(19) United States
(12) Patent Application Publication
(10) Pub. No.: US 2017/0199392 A1
(43) Pub. Date: Jul. 13, 2017

(54) LENS DRIVING APPARATUS

(71) Applicant: AAC Technologies Pte, Ltd., Singapore city (SG)

(72) Inventor: Shi Zhou, Shenzhen (CN)

(21) Appl. No.: 15/470,082

(22) Filed: Mar. 27, 2017

Related U.S. Application Data
(63) Continuation-in-part of application No. 14/535,737, filed on Nov. 7, 2014.

(51) Int. Cl. G02B 27/64

(52) U.S. Cl. CPC G02B 27/646

(57) ABSTRACT

A lens driving apparatus is disclosed in the present invention. The lens driving apparatus includes a stationary housing including a receiving space; a spring member connected to the stationary housing; a movable unit suspended in the receiving space by the spring member; a driving magnet set fixed in the stationary housing and surrounding the movable unit; an anti-shake coil set mounted on the stationary housing and including at least a pair of anti-shake coils having receiving holes, wound around an axis perpendicular to the optical axis and arranged opposite to each other along the axis; an anti-shake magnet set including at least a pair of anti-shake magnets mounted on the movable unit and corresponding to the anti-shake coils one by one with spacing; and at least a shake sensor received in one of receiving holes of the anti-shake coils and electrically connected to corresponding anti-shake coil.

### CROSS REFERENCE TO RELATED APPLICATION

This application is a continuation-in-part application of U.S. Ser. No. 14/535,737 filed on Nov. 7, 2014.

### FIELD OF THE INVENTION

The present disclosure generally relates to the art of driving apparatus, and more particularly to a lens driving apparatus with anti-shake function.

### DESCRIPTION OF RELATED ARTS

With the development of camera technologies, lens driving apparatus are widely used in various digital devices equipped with cameras, like cell phones, video cameras, laptop computers and so on.

A lens driving apparatus used in a digital device usually includes a lens holder, a lens disposed in the lens holder, a coil wound around the lens holder and a stationary magnet separated from the coil and interacted with the coil for generating an electromagnetic force for driving the coil together with the lens to move approaching or away along an optical axis. However, shakes occur easily in digital device equipped in mobile phones during the photographing process, such lens driving apparatus used in the digital device cannot suppress the shakes.

Therefore, an improved lens driving apparatus is provided in the present disclosure to solve the problem mentioned above.

### BRIEF DESCRIPTION OF THE DRAWINGS

Many aspects of the embodiment can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an illustrative isometric view of a lens driving apparatus according to an exemplary embodiment of the present disclosure.

FIG. 2 is an isometric exploded view of the lens driving apparatus in FIG. 1.

FIG. 3 is a cross-sectional view of the lens driving apparatus taken along line A-A in FIG. 1.

FIG. 4 is an illustrative isometric view of a flat spring of the lens driving apparatus in FIG. 2.

FIG. 5 is an illustrative isometric view of a lens holder of the lens driving apparatus in FIG. 2.

FIG. 6 is an illustrative isometric view showing that relative position between a driving coil, a driving magnet set, a lens holder, an anti-shake magnet set and an anti-shake coil set of the lens driving apparatus in FIG. 2.

FIG. 7 is a cross-sectional view of the lens driving apparatus taken along line A-A in FIG. 1, from another angle, with a movable unit, a spring member and a base case removed.

### DETAILED DESCRIPTION OF THE EXEMPLARY EMBODIMENT

While the invention is susceptible of embodiments in many different forms, there is shown in the drawings and will herein be described in detail embodiment of the invention with the understanding that the present disclosure is to be considered as an exemplification of the principles of the invention and is not intended to limit the broad aspect of the invention to the embodiment illustrated.

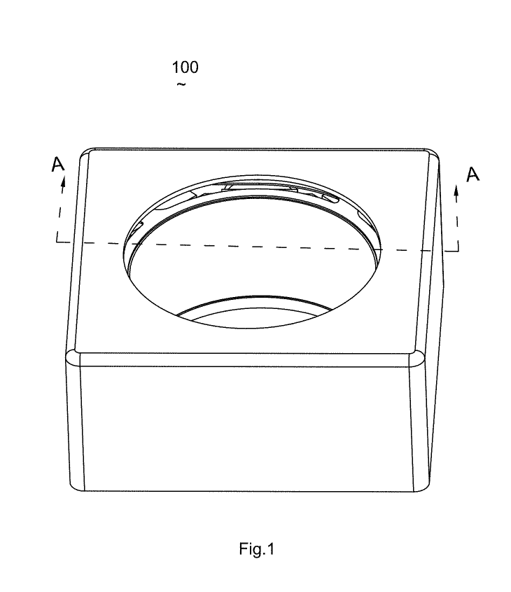

Referring to FIGS. 1-3, the illustrated lens driving apparatus 100 according to the exemplary embodiment of the present invention is mounted to a mobile terminal such as a camera-equipped cellular mobile phone which is enable automatic focusing (AF), a smart phone, a notebook personal computer, a tablet-type personal computer, a mobile-type game machine, a Web camera, a vehicle-mounted camera, or the like.

The lens driving apparatus 100 includes a stationary housing 10 including a receiving space 104, a spring member 11 connected to the stationary housing 10, a moveable unit 12 that defines an optical axis suspended in the receiving space 104 by the spring member 11, a driving magnet set 13 fixed to the stationary housing 10 for driving the movable unit 12 moving along the optical axis, an anti-shake coil set 14 mounted on the stationary housing 10, a shake sensor 15 received in the anti-shake coil set 14 and electrically connected to the anti-shake coil set 14, and an anti-shake magnet set 16 mounted on the movable unit 12 and facing the anti-shake coil set 14 with spacing for interacting with the anti-shake coil set 14 to generate magnetic force to drive the moveable unit 12 to move in a direction perpendicular to the optical axis. In this embodiment, the driving magnet set 13 includes a plurality of driving magnets 131 arranged around the movable unit 2 and spaced at uniform intervals with each other.

The stationary housing 10 includes a rectangular tubular upper case 102 and a base case 101 coupled to the upper case 102 for forming the receiving space 104. The upper case 102 has a circular opening 1020 concentric with the optical axis, and the base case 101 also has a circular opening 1010 concentric with the optical axis. The stationary housing 10 further includes a supporting frame 103 received in the receiving space 104 and mounted in the upper case 102.

A coordinate system (X, Y, Z) is used. The optical axis is referred as Z axis, and an upper direction of the optical axis is hereafter referred as a forward direction +Z (+Z side). When viewed from the +Z side, the four sides of the upper case 102 are denoted respectively by 1021, 1022,1023,1024 in a clockwise direction. The direction from the side 1023 toward the side 1021 is designated as a forward direction of the X axis (+X side); the direction from the side 1024 toward the side 1022 is designated as a forward direction of the Y axis (+Y side). The X axis and Y axis are orthogonal to the optical axis (Z axis) and perpendicular to each other.

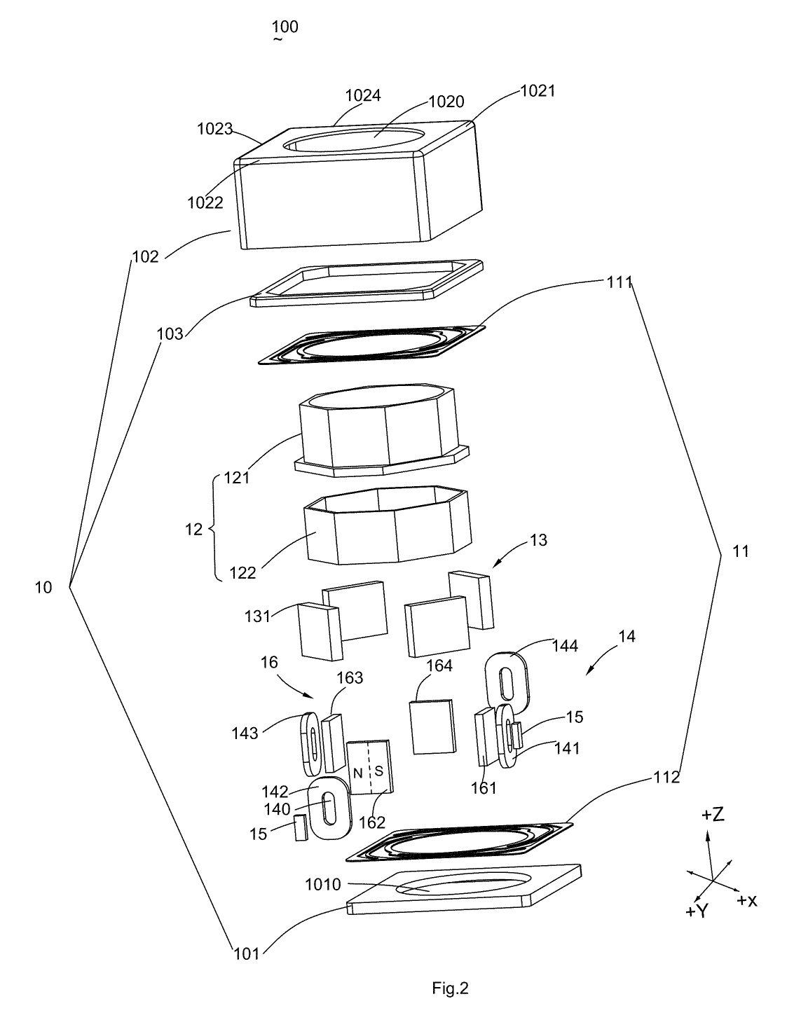

Referring to FIGS. 2-4, the spring member 11 comprises a pair of flat springs 111, 112 connected to an upper end and a lower end of the movable unit 12 respectively, which serves as swinging arrangements for swinging the movable unit 12 freely. Alternatively, the spring 111 is disposed at the lower end of the movable unit 12 along Z axis while the spring 112 is disposed at the upper end of the movable unit 12.

Each of the flat springs 111, 112 includes an outer frame 1111 of square plate-shape, an inner frame 1112 of circular plate-shape and a plurality of connecting arms 1113 provided between the outer frame 1111 and the inner frame 1112. That is, the plurality of connecting arms 1113 connects the outer frame 1111 to the inner frame 1112 for providing enough elastic force to the movable unit 12. The outer frame 1111 is fixed to the inner surface of the stationary housing 10, and the inner frame 1112 is fixed to an outer periphery of the movable unit 12. Specifically, the outer frame 1111 of the flat spring 111 is fixed to the supporting frame 103 of the stationary housing 10 by gluing while the inner frame 1112 of the flat spring 111 is fixed to the upper end of the movable unit 12; and the outer frame 1111 of the flat spring 112 is fixed to an upper surface of the base case 101 while the inner frame 1112 of the flat spring 112 is fixed to the lower end of the movable unit 12. Each of the flat springs 111,112 is made of beryllium copper, phosphor bronze, or the like.

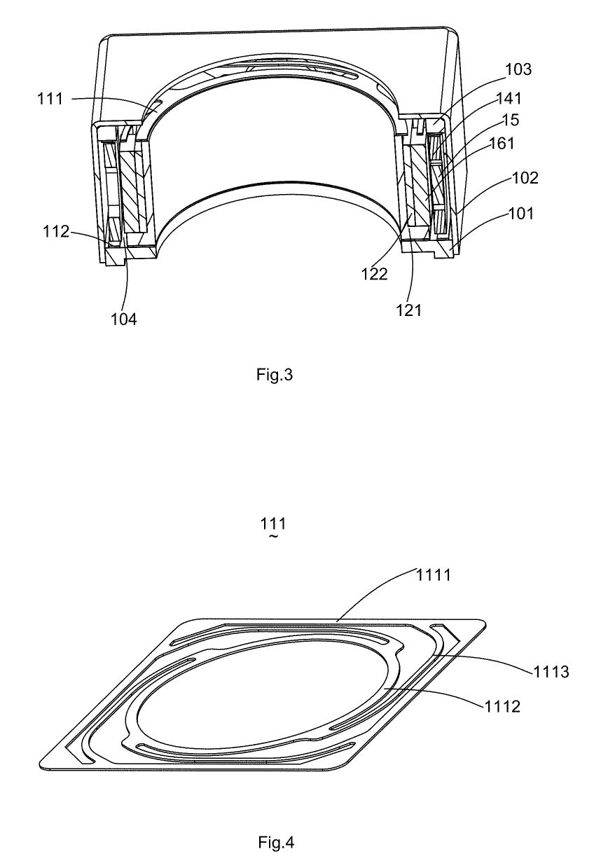

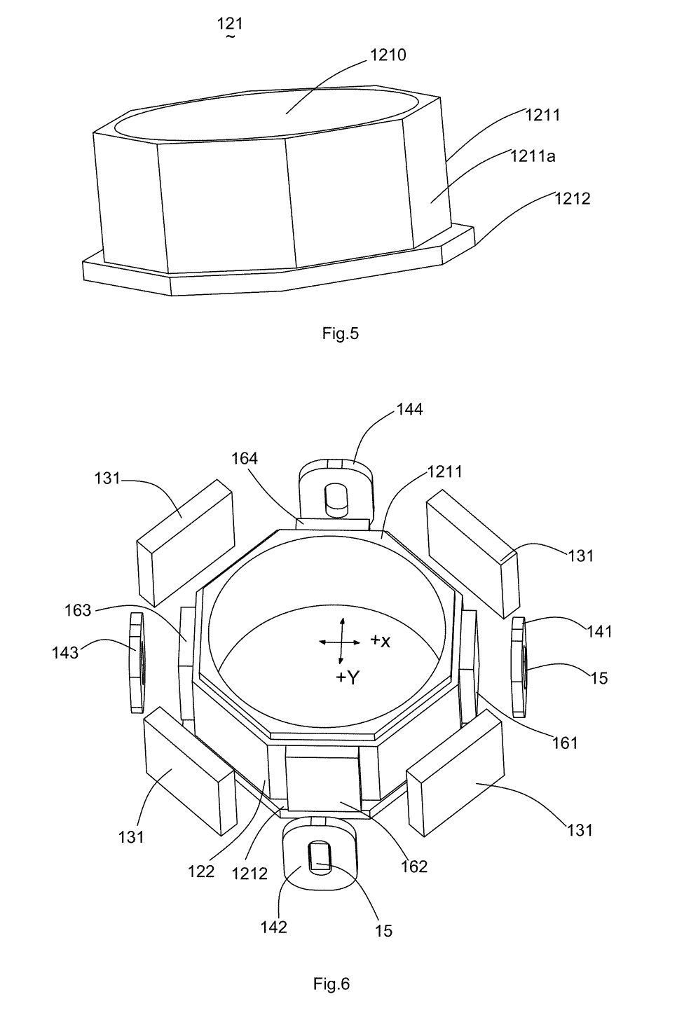

Referring to FIG. 2, FIG. 3, FIG. 5 and FIG. 6, the movable unit 12 comprise a lens module (not numbered) and a driving coil 122 fixed on an outer circumferential side of the lens module for driving the lens module to move along the optical axis Z. The lens module comprises a lens holder 121 and a lens (not shown) received in the lens holder 121. The lens holder 121 comprises a holder barrel 1211 and a mounting plate 1212 extending outward from a bottom end of the holder barrel 1211 along a radial direction thereof The holder barrel 1211 includes an octagonal shaped outer side 1211a disposed outside and a circumferential inner side opposite to the outer side. A chamber 1210 is formed in the central of the lens holder 121 for accommodating the lens. The mounting plate 1212 is octagonal ring-shaped. The diameter of the holder barrel 1211 is lower than that of the mounting plate 1212.

The driving coil 122 winds around the optical axis Z, is mounted on the outer circumferential side 1211a of the holder barrel 1211, electrically connected with an outer electric circuit (not shown), and is surrounded by the plurality of driving magnets 131 for interacting with the driving magnets 131 to generate a magnetic force to drive the movable unit 12 to move along the optical axis Z. The driving coil 122 is substantially octagonal ring-shaped to match the outer circumferential side 1211a of the holder barrel 1211.

The anti-shake coil set 14 comprises a first through fourth anti-shake coils 141-144, wherein the first and third anti-shake coils 141, 143 are wound around the X axis; and the second and forth anti-shake coils 142, 144 are wound around the Y axis. The first anti-shake coil 141 and the third anti-shake coil 143 are arranged respectively at the +X side portion and the −X side portion of sides 1021, 1023 of the upper case 102 of the stationary housing 10. The second and forth anti-shake coils 142,144 are arranged respectively at the +Y side portion and the −Y side portion of sides 1022, 1024 of the upper case 102 of the stationary housing 10. The first through forth anti-shake coils 141-144 are structured identical to each other and have receiving holes 140 formed in the center thereof, respectively. Each of the anti-shake coils 141-144 is positioned between each two adjacent driving magnets 131.

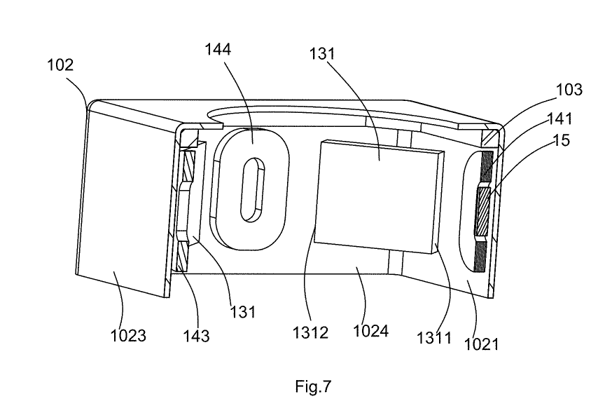

Referring to FIG. 7, each of the driving magnets 131 is fixed to the stationary housing 10 and located at the corners thereof The driving magnet 131 has a rectangular shape, and includes a first edge 1311 and a second edge 1312 opposite to the first edge 1311. Optionally, the first edge 1311 of the driving magnet 131 is fixed on the side 1021 of the upper case 102, and the second edge 1312 of the driving magnet 131 is fixed on the side 1024 of the upper case 102.

The anti-shake magnet set 16 comprises a first through forth anti-shake magnets 161-164 having a magnetic fields in directions perpendicular to surfaces of the first through forth anti-shake coils 141-144, corresponding to the first through forth anti-shake coils 141-144 one by one with spacing and mounted on an upper surface of the mounting plate 1212 of the lens holder 121. Each of the first through forth anti-shake magnets 161-164 has a first part and a second part connected to the first part. The first part has a first pole, and the second part has a second pole. In this embodiment, the polarity of the first pole and the polarity of the second pole are traversed to each other. The area of each anti-shake magnet is less than that of the driving magnet 1222.

Two shake sensors 15 are provided in this embodiment. The two shake sensors 15 are received in the receiving holes 140 of the first anti-shake coil 141 and second anti-shake coil 142 respectively for detecting the direction and degree of a shake that causes the movable unit 12 to move in the axis perpendicular to the optical axis Z. Each of the shake sensors 15 is Hall element.

When a shake occurs in the stationary housing, the shake sensors 15 detect the direction and degree of the shake and send them to the outer electric circuit. The outer electric circuit controls the magnitudes and directions of the currents powering the first through forth coils 141-144 according to the detected degree and direction of the shake so that the movable unit 12 can move to suppress the shake. For example, when the shake causes the movable unit 12 to move in -X direction occurs, the shake sensor 15 received in the first coil 141 detects direction and degree of the shake and sends them to the outer electric circuit. The outer electric circuit controls the magnitudes and directions of the currents powering the first and third anti-shake coils 141,143 according to the detected degree and direction of the shake. The first and third anti-shake coils 141,143 interact with the first and third anti-shake magnets 161,163 to generate magnetic force to drive the movable unit 12 to move in +X direction so that the shake that causes the movable unit 12 to move in −X direction can be suppressed.

While the present invention has been described with reference to a specific embodiment, the description of the invention is illustrative and is not to be construed as limiting the invention. Various of modifications to the present invention can be made to the exemplary embodiment by those skilled in the art without departing from the true spirit and scope of the invention as defined by the appended claims.

What is claimed is:

1. A lens driving apparatus, comprising:
a movable unit having an optical axis and comprising:
a lens holder including a holder barrel and a mounting plate extending outwardly from a bottom end of the holder barrel in a radial direction thereof;
a driving coil wound around an outer circumferential side of the holder barrel; and
an anti-shake magnet set including at least a pair of anti-shake magnets mounted on an upper surface of the mounting plate for moving together with the lens holder and facing to the driving coil with space;
a stationary unit comprising:
a stationary housing configured for holding the movable unit;
a spring member connected the movable unit to the stationary housing;
a driving magnet set fixed to the stationary housing and surrounding the driving coil for driving the movable unit moving along the optical axis;
an anti-shake coil set mounted on the inner surface of the stationary housing and spaced from the driving magnet set, and comprising at least a pair of anti-shake coils having receiving holes that wind around an axis perpendicular to the optical axis and arranged opposite to each other along the axis; wherein, each of the anti-shake coils faces to one of the anti-shake magnets with space for correction shake of the lens holder;
and
at least a shake sensor received in one of receiving holes of the anti-shake coils and electrically connected to the corresponding anti-shake coil.

2. The lens driving apparatus of claim 1, wherein each of the anti-shake magnets comprises a first part and a second part connected to the first part, the first part having a first pole and the second part having a second pole, wherein the polarity of the first and second poles are traversed to each other.

3. The lens driving apparatus of claim 2, wherein the area of the anti-shake magnet is less than that of the driving magnet.

4. The lens driving apparatus of claim 3, wherein the spring member comprises a pair of flat springs connected to an upper end and a lower end of the lens holder respectively.

5. The lens driving apparatus of claim 4, wherein each of the flat springs comprises an outer frame fixed to the housing, an inner frame fixed to the lens holder, and a plurality of first arms provided between the outer frame and the inner frame.

6. The lens driving apparatus of claim 5, wherein the anti-shake coil set comprises a first through fourth anti-shake coils; wherein, the first and third anti-shake coils wound around a first axis perpendicular to the optical axis and opposite to each other along the first axis; the second and fourth anti-shake coils wound around a second axis perpendicular to the optical axis and opposite to each other along the second axis; wherein the first axis is perpendicular to the second axis; and
the anti-shake magnet set comprises a first through fourth anti-shake magnets corresponding to the first through fourth anti-shake coils one by one and facing to corresponding anti-shake coils with space.

7. The lens driving apparatus of claim 1, wherein the holder barrel includes an octagonal shaped outer side disposed outside and a circumferential inner side opposite to the outer side.

8. The lens driving apparatus of claim 1, wherein the mounting plate is octagonal ring-shaped.

9. The lens driving apparatus of claim 1, wherein the stationary housing includes an upper case and a lower case assembled with the upper case, the driving magnet set is fixed to the upper case.

10. The lens driving apparatus of claim 9, wherein the upper case includes four sides connected with each other;
the driving magnet set includes a plurality of driving magnets, each of the driving magnets including a first edge and a second edge opposite to the first edge, wherein, the first edge is fixed to one side of the upper case, and the second edge is fixed to another side of the upper case adjacent to the side connected with the first edge.

11. A lens driving apparatus, comprising:
a movable unit movable along an optical axis and comprising:
a lens holder including a holder barrel and a flange extending outwardly from a bottom end of the holder barrel;
a driving coil wound around the holder barrel; and
an anti-shake magnet set including at least a pair of anti-shake magnets carried by the flange for moving together with the lens holder and facing to the driving coil with a gap therebetween;
a stationary unit comprising:
a stationary housing for holding the movable unit;
a spring member elastically suspending the movable unit;
a driving magnet set fixed to the stationary housing and surrounding the driving coil for driving the movable unit moving along the optical axis, the driving magnet set comprising a plurality of driving magnets each positioned between two adjacent sides of the stationary housing;
an anti-shake coil set mounted on an inner surface of the stationary housing, the anti-shake coil set comprising at least a pair of anti-shake coils each forming a receiving hole and facing one of the anti-shake magnets with a space for correction shake of the lens holder; and
at least a shake sensor received in the receiving hole of the anti-shake coil and electrically connected to the corresponding anti-shake coil.

12. The lens driving apparatus of claim 11, wherein the stationary housing includes an upper case and a lower case assembled with the upper case, the driving magnet set is fixed to the upper case.

13. The lens driving apparatus of claim 12, wherein the upper case includes four sides connected with each other, the driving magnet includes a first edge fixed to one side of the upper case and a second edge parallel to the first edge and fixed to another adjacent side of the upper case.
